(19) United States
(12) Patent Application Publication
(10) Pub. No.: US 2023/0165384 A1
(43) Pub. Date: Jun. 1, 2023

(54) METHOD FOR SETTING UP AT LEAST ONE FURNITURE DRIVE

(71) Applicant: Julius Blum GmbH, Hoechst (AT)

(72) Inventors: Thomas RUEDISSER, Hohenems (AT); Florian BURTSCHER, Dornbirn (AT); Thomas TAIMLER, Hoechst (AT)

(21) Appl. No.: 18/072,102

(22) Filed: Nov. 30, 2022

Related U.S. Application Data
(63) Continuation of application No. PCT/AT2021/060194, filed on Jun. 2, 2021.

(30) Foreign Application Priority Data
Jun. 5, 2020 (AT) A 50490/2020

(51) Int. Cl. A47C 31/00; G05B 15/02

(52) U.S. Cl. CPC A47C 31/008; G05B 15/02

(57) ABSTRACT

A method is provided for setting up a furniture drive via an electronic device, in particular a mobile terminal, smart phone, or computer, and the furniture drive includes a storage unit. The method includes, preferably in chronological order: in an assembly operator region of the electronic device, storing a digital data set relating to at least one static parameter and/or a dynamic parameter on the storage unit via the electronic device, in particular as a wireless signal transmission; and storing in an end user region of the electronic device, a digital data set relating to the dynamic parameter on the storage unit via the electronic device, in particular as a wireless signal transmission.

### BACKGROUND OF THE INVENTION

The invention concerns a method for setting up at least one furniture drive via at least one electronic device, in particular mobile terminal, smartphone or computer, wherein the at least one furniture drive comprises at least one storage unit. Furthermore, the invention concerns a method for setting up a furniture arrangement via at least one electronic device, in particular mobile terminal, smartphone or computer, wherein the furniture arrangement comprises at least one furniture part movably positioned on a furniture carcass and at least one furniture drive with at least one storage unit, wherein the at least one furniture part can be arranged by the at least one furniture drive in at least two operating positions relative to the furniture carcass. Furthermore, the invention concerns a computer program product for carrying out such a method. The invention further concerns a furniture arrangement comprising at least one furniture drive with at least one storage unit and at least one furniture part movably positioned on a furniture carcass, wherein the at least one furniture part can be arranged by the at least one furniture drive in at least two operating positions relative to the furniture carcass, and at least one electronic device, in particular mobile terminal, smartphone or computer, in particular spatially separate from the at least one furniture drive, wherein it is preferably provided that the at least one furniture drive and the at least one electronic device each comprise at least one data forwarding device. The invention further concerns a furniture drive for such a furniture arrangement, comprising at least one fixing device for fixing the furniture drive to a furniture carcass, at least one positioning device, by means of which at least one moveable furniture part can be moved relative to the furniture carcass, at least one drive unit, by means of which the at least one positioning device can be driven, in particular electrically, in particular at least one computing unit and/or at least one data forwarding device, and at least one storage unit.

Electronic devices in connection with furniture drives are known from the prior art—for instance by WO 2019/145440 A1—wherein the electronic devices are provided for controlling the furniture drives. For example, the furniture drives can be operated via a smartphone in such a way that a piece of furniture moves into various operating positions via the controlled furniture drives. Control commands generated by the electronic device are forwarded to an evaluation unit and realized in a movement of positioning devices.

A disadvantage of the prior art is that all the data relevant for smooth operation of the furniture drive must already be stored in an assembly step for the furniture drives—for instance via an HMI arranged on the furniture drive—which means that a flexibility of the system is limited to the stored motion data, and no convenient storage is provided. In addition, control commands which cause furniture parts to collide can only be inhibited via a further control command in the sense of an emergency stop control command, wherein this requires increased attention of a user during an operation of the furniture drives, and a user-friendliness of the system is reduced. In addition, a user of the furniture is not provided with the possibility of adapting the control commands, wherein, for instance, in case of a language deficiency and/or in case of insufficient language skills of a user of the furniture, using the system is considerably impeded.

### SUMMARY OF THE INVENTION

The objective technical object of the present invention is therefore to disclose an improved method, compared to the prior art, for setting up at least one furniture drive, as well as disclosing methods for setting up a furniture arrangement, in which the disadvantages of the prior art are at least partially eliminated, and which are characterized in particular by a user-friendly and/or flexible storage of data relevant to operate a piece of furniture out of a remote position. Furthermore, an improved computer program product, an improved furniture arrangement and an improved furniture drive are disclosed.

It is therefore provided according to the invention that the following method steps, preferably to be carried out in chronological order, are performed:
in an assembly operator area of the at least one electronic device, at least one digital data set relating to at least one static parameter and/or at least one dynamic parameter, in particular wireless signal transmitting, is stored in the at least one storage unit via the at least one electronic device,
in an end user region of the at least one electronic device, at least one digital data set relating to the at least one dynamic parameter, in particular wireless signal transmitting, is stored in the at least one storage unit via the at least one electronic device.

This only makes it possible for the digital data sets to be flexibly adjustable to circumstances and/or requirements of a furniture arrangement, and to be adapted in a user-friendly manner at any time, wherein only the configuration options of the furniture drive that are relevant for him/her or that are to be permitted for safety reasons are visible particularly to an assembler and/or a user.

Added to this is the positive characteristic that, in the case of wireless signal transmitting storage by the assembler and/or by the user, an immediate proximity to furniture drives is not required for setup, provisioning and/or configuration, and setup, provisioning and/or configuration can also be carried out conveniently from remote premises, for instance. In general, however, the storage can also be carried out cable-based.

In general, the at least one electronic device can also act as a command transmitter for the furniture drive in order to initiate a movement of a moveable furniture part, wherein controlling the furniture drive can be performed, for instance, by a voice-controlled and/or tactilely operable app on the at least one electronic device. For instance, limited command options for specific users can be provided in the end user region in order to be able to generate only those commands for which the respective user is authorized. This can prevent a child, for instance, from activating a furniture drive that controls a moveable piece of furniture covering dangerous contents.

In addition, sensitive user data can remain hidden in the assembly operator area, wherein a more extensive configuration option is made possible by an expanded spectrum of static parameters to be stored. If the dynamic parameters are already known, they can already be stored in the assembly of the furniture drive via the at least one digital data set. However, it is also possible to modify the dynamic parameters by the user at a later point in time.

The static parameters enable a furniture drive, for instance by matching a digital command by a command transmitting unit, to be able to ensure the kitchen to be operated properly without collision of moveable furniture parts and/or with synchronized movements of moveable furniture parts by further furniture drives. A static parameter can, for instance, image a state of a furniture drive, which defines an opened or closed furniture part and/or a locked or unlocked furniture drive.

The dynamic parameters enable a user, for instance, to store contents designations for a furniture drive, wherein the furniture drive is in connection with a moveable furniture part covering a storage space, and/or to define when a furniture drive shall open the moveable furniture part, or at which point in time the moveable furniture part shall not be openable by the furniture drive. In general, different authorizations for specific users can be stored for a furniture drive via a dynamic parameter.

As stated at the beginning, protection is also sought for a method for setting up a furniture arrangement, wherein the following method steps, which are preferably to be carried out in chronological order, are performed:
in an assembly operator area of the at least one electronic device, at least one digital data set relating to at least one static parameter and/or at least one dynamic parameter, in particular wireless signal transmitting, is stored in the at least one storage unit via the at least one electronic device,
in an end user region of the at least one electronic device, at least one digital data set relating to at least one dynamic parameter, in particular wireless signal transmitting, is stored in the at least one storage unit via the at least one electronic device.

As stated at the beginning, protection is also requested for a computer program product comprising commands which, when executed by a computing unit, cause the computing unit to execute, from a storage unit which is or can be brought into a data connection with the computing unit, a method according to at least one of the preceding claims.

The computer program product can for instance be stored in the at least one storage unit and executed by the at least one computing unit.

As stated at the beginning, protection is also sought for a furniture arrangement wherein the at least one storage unit is designed in order to do the following:
in an assembly operator area of the at least one electronic device, at least one digital data set relating to at least one static parameter and/or at least one dynamic parameter, in particular wireless signal transmitting, can be stored in the at least one storage unit via the at least one electronic device,
in an end user region of the at least one electronic device, at least one digital data set relating to at least one dynamic parameter, in particular wireless signal transmitting, can be stored in the at least one storage unit via the at least one electronic device.

As stated at the beginning, protection is also sought for a furniture drive wherein the at least one storage unit is designed in such a way that at least one digital data set relating to at least one static parameter and/or dynamic parameter, in particular wireless signal transmitting, can be stored in the at least one storage unit via at least one electronic device, in particular mobile terminal, smartphone, or computer.

According to an advantageous embodiment of the invention, the at least one electronic device and the at least one furniture drive are designed spatially separate from each other. This considerably increases a convenience when storing a digital data set. The assembler and/or the user can configure a plurality of furniture drives from a remote location, wherein user-friendliness can be increased, especially for possibly necessary reference drives for large furniture and/or furniture parts difficult to be moved, and additional personnel can be dispensed with for configuring the furniture drive.

Furthermore, static parameters such as collision parameters and/or synchronization parameters, which are related to further furniture parts, can be transmitted to the at least one storage unit without changing a configuration position for storing the at least one digital data set.

Advantageously, the assembly operator area and the end user region are separated from each other, preferably by separate logins and/or separate apps, on the at least one electronic device. Preferably, in the assembly operator area and/or the end user region, data communication between the at least one electronic device and the at least one furniture drive is enabled in encrypted form and/or during defined time windows. This can prevent a user from entering the assembly operator area or an assembler from entering the end user's area and changing static and/or dynamic parameters of the furniture drive that are not assigned to his scope of duties.

It is particularly preferred that data communication is also enabled in an assembly operator area located on a first electronic device and an end user's area located on a second electronic device, in an encrypted manner and/or during defined time windows.

An advantageous variant is that the at least one digital data set of the assembly operator area and/or the end user region of the at least one storage unit is stored via at least one data transmission device spatially separate from the at least one electronic device, wherein it is preferably provided that the at least one electronic device communicates with the at least one data transmission device via WiFi and/or WAN, and/or the at least one data transmission device communicates with the at least one furniture drive via ESB.

If the electronic device does not have a radio protocol via which to communicate with the furniture drive, the at least one data transmission device can forward a digital command via a radio protocol with which the at least one furniture drive can receive digital data, wherein the data transmission device generates a translation between the two radio protocols in order to store the at least one digital data set of the at least one storage unit and/or to transmit a command to control the furniture drive. In particular, a data communication can be performed according to a forwarding protocol according to IEEE 802.11 standard and/or Bluetooth standard. In general, the translation can also take place in a cloud.

In general, the furniture drive can communicate with at least one additional furniture drive and, for instance, match the at least one digital data set with at least one digital data set of the at least one additional furniture drive and/or share the at least one digital data set with the at least one additional furniture drive, wherein a data communication is particularly preferred via ESB.

The technical term ESB as a radio protocol refers to Enhanced Shockburst™, which has proven to be particularly advantageous for controlling furniture drives compared to BLE due to its lower latency periods, among other things.

In general, data communication can be understood as data forwarding by means of sending and receiving, wherein preferably, at least partially, only sending or receiving takes place. However, unidirectional data communication is also conceivable, wherein for instance feedback by means of digital information is dispensed with. Data communication via radio signal protocols is particularly preferred, wherein in general a wired data communication is also possible. A receiver unit and a transmitter unit can for instance be present integrated on a chip or spatially separate from each other.

It has proved advantageous that a data communication between the at least one electronic device and the at least one furniture drive takes place bidirectionally, wherein it is preferably provided that the at least one electronic device determines information, preferably at least one digital data set, at least one additional furniture drive and/or a network in which the at least one furniture drive is mapped, by a connection with at least one, preferably exactly one, furniture drive and/or at least one, preferably exactly one, data transmission device that may be provided.

This can confirm and/or indicate to the at least one electronic device, for instance, a change of state and/or a successful storage of the at least one digital data set. In general, information about additional entities of a network in which the furniture drive is located is accessible to the electronic device through a connection with only one furniture drive.

According to an advantageous embodiment of the invention, it is provided that the assembly operator area is installed on at least one electronic device, and the end user region is installed on at least one additional electronic device spatially separate from the at least one electronic device, or the assembly operator area and the end user region are installed on the same electronic device.

The assembly operator area and the end user region are generally decoupled from each other, so that a user can, for instance, install an app on his/her smartphone, which only provides access to the end user region, but does not provide access to the assembly operator area.

It has proved advantageous that the at least one electronic device communicates with the at least one furniture drive via BLE.

It is particularly preferred that the at least one electronic device with at least one data forwarding device communicates directly with a data forwarding device of the furniture drive. BLE has proved to be particularly advantageous as a forwarding protocol or radio protocol for data communication.

The technical term BLE as a radio protocol means Bluetooth Low Energy, which is integrated on commercially available electronic devices such as smartphones or computers.

It is particularly preferred that the assembly operator area and/or the end user region can be operated in response to a verbal voice command given by a user, preferably with user identification, and/or in a tactile manner.

An advantageous variant is that the at least one tactile command and/or the at least one verbal voice command of the at least one command transmitter and/or in at least one cloud is translated into at least one digital command for controlling the furniture drive and/or into the at least one digital data set provided for storage. Thus, a homogenization of the commands obtained by a user can be obtained, which can be transmitted to the data forwarding device via a suitable radio protocol with low latency.

The voice command makes it particularly convenient to control and/or configure the at least one furniture drive via the at least one electronic device, since a user can, for instance, generate an opening or closing of specific, moveable furniture parts by means of a suitable word or sequence of words, and/or can assign storage spaces with specific contents with individual identifications. By means of a user identification, a digital command of a specific person can, for instance, initiate a furniture drive not to move a moveable furniture part and/or generate no storage of a digital data set in the at least one storage unit. Moreover, the voice commands are individually adaptable, wherein for instance the term “salt” can generate an opening of that moveable furniture part having a salt shaker in its storage space, which increases a user-friendliness of the network. The term “open” can, for instance, entitle a static state parameter in the assembly process of the furniture drive, which changes into a modified state parameter when an operating position of a moveable furniture part is changed. A digital command can comprise an operation command and/or a control command. The data relevant for a furniture control can be stored in the static parameters and dynamic parameters in the at least one storage unit.

The number of entities located in the network is generally arbitrary. Without knowing an exact position of a desired contents item, the latter is made accessible to a user with the help of a simple verbal command, wherein an opening of the moveable furniture part is generated at least partially by the at least one furniture drive, in order to be able to take out the desired contents item. The static parameters and/or dynamic parameters required for this can be completely comprised by the at least one digital data set. By means of a verbal command deviating therefrom, such as for instance “sugar”, a contents item of a separate storage space can be made accessible.

In one embodiment of the invention, the at least one static parameter is in the form of a reference parameter, synchronization parameter, coupling parameter, state parameter, and/or collision parameter, wherein it is preferably provided that the state parameter is changed depending on at least one operating position.

Reference parameters are, for instance, defined end positions of at least one positioning device, which define operating positions of the at least one furniture drive. Synchronization parameters are, for instance, time-defined sequences of an activation of at least one drive unit, in order to coordinate a plurality of furniture drives for moving the at least one furniture part. Coupling parameters are understood to mean, for instance, a linkage of a furniture drive to a/an command transmitting unit, household appliance, remote switch element, additional furniture drive and/or the like, in order to define a connection between two entities of a network. State parameter means, for instance, a locking and/or position of the at least one positioning device which images an opened or closed moveable furniture part, wherein the state parameter can be modified in a transition between operating positions of the at least one moveable furniture part. The static parameters are not limited to the parameters mentioned, and can comprise, for instance, further assembly settings relevant for a furniture arrangement.

Generally, the furniture drive can be coupled to a furniture lock that enables the furniture drive to be locked, and/or the furniture drive itself has a locking device that transitions to a locked state or an unlocked state through the assembly operator area and/or the end user region, particularly at specific times.

According to a preferred embodiment of the invention, the at least one dynamic parameter is in the form of a time parameter, locking parameter, and/or storage space parameter.

For instance, the furniture drive can be arranged on a piece of furniture in which a microwave oven and/or coffee machine is placed, wherein a closing of a moveable furniture part is to be inhibited during operation of these household appliances. This can be done via the assembly operator area and/or the end user region by storing a locking parameter. The locking parameter can be bound to a household appliance operating, be defined depending on a time interval in which a locking of the furniture drive should be given and/or be individually adjustable by a user.

The time parameter can include, for instance, at which point in time a furniture drive should move a moveable furniture part into an open operating position and/or at which point in time no digital command should be executed to open the moveable furniture part by the furniture drive. The storage space parameter can be used to individually define storage spaces and/or the contents contained therein, wherein these for instance are made accessible to the user by a verbal command to a speech recognition system. A change of the dynamic parameters is possible at any time by accessing the end user region. The dynamic parameters can generally comprise further user settings relevant for running a kitchen.

The at least one electronic device can for instance be present in the form of a tablet with a speech recognition system, wherein a spatially separate speech recognition system can also be integrated in the network.

It has proved advantageous that, in the assembly operator area:
the at least one furniture drive is coupled to at least one additional furniture drive and/or synchronized via a reference drive to be performed by a user,
the at least one furniture drive is initialized via a reference drive to be performed by a user,
the at least one furniture drive is coupled to at least one command transmitting unit, wherein preferably the at least one command transmitter is initialized via a reference drive to be performed by a user,
a collision avoidance is stored in the at least one storage unit via a reference drive to be performed by a user, and/or
the at least one furniture drive, at least one command transmitter and/or at least one data transmission device are added to a network.

By means of a reference drive, the furniture drive can be trained in a particularly favorable manner to the conditions on site, such as required operating positions of a moveable furniture part, into which the moveable furniture part is moved by the furniture drive, wherein the digital data set can contain information on additional furniture drives, such as impending collisions or necessary synchronizations for a proper movement of moveable furniture parts. The digital data set can be stored during a reference drive and/or before or after the reference drive of the storage unit.

If the at least one command transmitting unit, additional furniture drives and/or the data transmission device are known to the electronic device and/or the furniture drive, a resilience of the network is increased, wherein a susceptibility to errors is reduced. Furthermore, log information can be read out and/or analyzed in a particularly favorable manner via the at least one electronic device, since digital data of further entities of the network are accessible by a connection to an entity.

Through the log information, the user/assembler has access to information regarding product usage, which can be evaluated in particular anonymously and/or for instance can be transmitted to a support with data regarding a frequency of usage as well as point of time of usage of specific furniture drives, language, temperature, humidity, sensor data, kitchen size, etc.

Furthermore, it is preferably provided that in the assembly operator area:
at least one network address, at least one link key and/or at least one naming is assigned and/or allocated,
at least one current state, at least one log information and/or at least one operating information of the at least one furniture drive and/or at least one possibly present command transmitter and/or a possibly present data transmission device is read out,
preferably at least one error message is displayed to at least one furniture drive and/or a possibly present data transmitting unit and/or a possibly present command transmitting unit,
at least one furniture drive, at least one data transmission device and/or at least one command transmitter is added to form a network,
at least one furniture drive, at least one possibly present data transmission device and/or at least one possibly present command transmitter is reset, unlocked or locked and/or set active or inactive,
at least one update, preferably a firmware update, of the at least one electronic device, the at least one furniture drive, a possibly present command transmitter and/or a possibly present data transmission device is updated, and/or
at least one operating manual and/or help dialog for configuration is displayed.

This increases an up-to-dateness of the network as well as a performance of the network. In addition, for instance, the at least one operating manual and/or the at least one help dialog facilitate assembling the furniture drive, in particular in a furniture arrangement.

Particularly preferably, in the end user region:
at least one current state of the at least one furniture drive is read out,
at least one furniture drive, at least one possibly present data transmission device and/or at least one possibly present command transmitter is set active or inactive and/or unlocked or locked,
at least one support access, in particular live support access, is made possible,
at least one update, preferably a firmware update of the at least one electronic device, of the at least one furniture drive, of a possibly present command transmitter and/or of a possibly present data transmission device is updated, and/or
at least one operating manual and/or help dialog for configuration is displayed.

Thus, a current situation of the furniture drive, in particular in connection with a furniture arrangement, can be viewed quickly and remotely from the furniture arrangement, a comfortable operation or configuration of the furniture drive as well as an update to current software is possible, wherein in case of any problems in the handling of the electronic device and/or the furniture drive, operating assistance is provided.

Alternatively, it is possible that the at least one furniture drive comprises at least one fixing device for fixing the furniture drive to a furniture carcass, at least one positioning device with which at least one moveable furniture part can be moved relative to the furniture carcass, and at least one drive unit with which the at least one positioning device can be driven, in particular electrically, wherein it is preferably provided that the at least one furniture drive comprises at least one computing unit.

The at least one fixing device enables a position-safe positioning, in particular in a piece of furniture, wherein a force for moving the at least one moveable furniture part is provided by the at least one drive unit, which force is transmitted by the at least one positioning device to the at least one moveable furniture part for moving the at least one moveable furniture part.

In a further preferred embodiment, the at least one furniture drive comprises at least one data forwarding device via which, preferably via a data forwarding device of at least one additional furniture drive, at least one static parameter of at least one additional furniture drive, at least one dynamic parameter of at least one additional furniture drive and/or at least one piece of information, preferably at least one digital data set, relating to a network in which the at least one furniture drive is located, is determined and/or stored in the at least one storage unit.

The at least one data forwarding device can generally comprise a transmitting unit and/or a receiving unit, which are arranged on a chip or spatially separate from each other on the furniture drive.

According to an advantageous embodiment of the invention, the entire furniture arrangement is configurable in the assembly operator area and/or in the end user region.

The prior art does not offer any possibility of configuring a plurality of pieces of furniture, furniture drives and/or moveable furniture parts by means of an entity, which can be mapped as an entity in a network, and/or of storing digital data sets for the furniture drives connected to the pieces of furniture. More flexibility is hereby offered by the solution with the assembly operator area and/or end user region, via which the at least one storage unit of individual furniture drives can be specifically filled with digital data sets.

For instance, an assembler assembles a kitchen with a plurality of furniture drives of different pieces of furniture, wherein the plurality of furniture drives can be configured wireless signal transmitting via the electronic device without a necessary change of position of the assembler by storing digital data sets.

In an analogous way, a user can configure the entire kitchen via the furniture drives therein and adjust to the desired characteristics.

According to an advantageous embodiment of the invention, an assembly operator area evoked by the computer program product is displayable on at least one electronic device, and an end user region evoked by the computer program product is displayable on at least one electronic device spatially separate therefrom, or the assembly operator area and the end user region evoked by the computer program product are displayable on the same electronic device.

Advantageously, the furniture arrangement comprises at least one data transmission device and/or at least one command transmitter for transmitting at least one digital data set and/or at least one digital command.

This enables the furniture drives of the furniture arrangement to move the at least one moveable furniture part considering the digital command, wherein for instance a selection for feasibility or non-feasibility can be made by comparing the at least one digital command with the at least one digital data set, thus preventing collisions and/or generating synchronous movements with additional furniture drives.

It has proved advantageous that the at least one command transmitter is designed in the form of the at least one electronic device, a remote switch element, a data transmission device, a furniture lock, a household appliance and/or an additional furniture drive.

By means of the at least one digital data set of the storage unit and the at least one digital command, a proper movement of the at least one moveable furniture part without a risk of collisions of the at least one moveable furniture part can take place, an undesired opening or closing of the at least one moveable furniture part can be prevented and/or a common parallel or common sequential movement of the moveable furniture parts with at least one additional furniture drive can take place.

According to an advantageous embodiment of the invention, the at least one data forwarding device comprises at least one ELB module for data communication with the at least one electronic device via ELB, and/or at least one ESB module for data communication with at least one command transmitting unit, at least one data transmission device, and/or at least one additional furniture drive via ESB.

It has proved to be advantageous that at least one digital command of the at least one command transmitter and/or of the at least one data transmission device can be transmitted to the at least one data forwarding device of the at least one furniture drive, preferably wireless signal transmitting, wherein the at least one computing unit is designed such that the at least one digital command is compared with at least one digital data set stored in the at least one storage unit, and the at least one computing unit is designed such that, depending on a result of the comparison, to make a selection for carrying out the at least one digital command.

This only makes it possible for the at least one furniture drive to have its own autonomous self-intelligence, separate from the command transmitting unit, via which the at least one furniture drive can check the at least one digital command of the at least one command transmitter with regard to feasibility. If the at least one digital command cannot be executed, for instance due to an impending collision, without risking damage to the at least one moveable furniture part, the at least one furniture drive can prevent executing the at least one digital command, wherein in case of a plurality of furniture drives, data communication only has to take place with one furniture drive in order to be able to execute a synchronous movement and/or in order to be able to avoid a collision.

For instance, for a piece of furniture in the form of a shelf or a base cabinet, at least one furniture drive of an internal pull-out is actuated by a voice command of a speech recognition system, in particular of the at least one electronic device, wherein at least one additional furniture drive of a front pull-out is activated parallelly or sequentially synchronized in order to move the two moveable pieces of furniture by a digital command of the command transmitting unit. If a collision is impending, the movements are inhibited, wherein if the synchronization is correct and there is no potential collision, the movements are carried out, wherein the information relevant therefor is stored in the form of the static parameters and/or dynamic parameters of the at least one digital data set in the at least one storage unit. The feasibility as well as a changed state of the operating positions of the moveable furniture parts are transmitted to the command transmitting unit, in particular to the at least one electronic device, in the form of digital information. Via an app, a user is informed about changes to the piece of furniture, and can possibly change the at least one digital data set via the end user region.

Synchronized furniture drives can control a motion sequence of the at least one moveable furniture part due to a temporal offset and/or due to a spatial position of the at least one moveable furniture part relative to a furniture carcass or further moveable furniture parts, such as minimum aperture angles, wherein in particular a danger of a collision can be checked at any time by the at least one furniture drive.

### BRIEF DESCRIPTION OF THE DRAWINGS

Further details and advantages of the present invention are explained in more detail below by means of the figure description with reference to the embodiments shown in the drawings.

They show:

FIG. 1 shows a furniture arrangement of four furniture drives, an electronic device, and a plurality of command transmitting units connected in a network, in a schematic overview illustration,

FIG. 2a-2f show a data communication of electronic devices or command transmitting units to a furniture drive, wherein the furniture drive is in data communication with an additional furniture drive, in a schematic illustration,

FIG. 2g-2h show an electronic device in data connection with a furniture lock and a command transmitter in a schematic illustration,

FIG. 3a shows two electronic devices, wherein an assembly operator area is displayed on one electronic device, and an end user region is displayed on the second electronic device, during a transmission of two digital data sets to a furniture drive in a schematic illustration,

FIG. 3b shows an electronic device with an installed app with the assembly operator area and the end user region, a transmission of a digital data set to a data forwarding device of the furniture drive in a schematic illustration,

FIG. 4a shows a furniture arrangement consisting of a piece of furniture with a furniture carcass and a moveable furniture part in the form of a furniture flap as well as two command transmitting units in a perspective view,

FIG. 4b shows a furniture arrangement with a piece of furniture and five pieces of furniture in the form of drawers which are moveable relative to a furniture carcass, as well as an electronic device and a data transmission device in a perspective view.

### DETAILED DESCRIPTION OF THE INVENTION

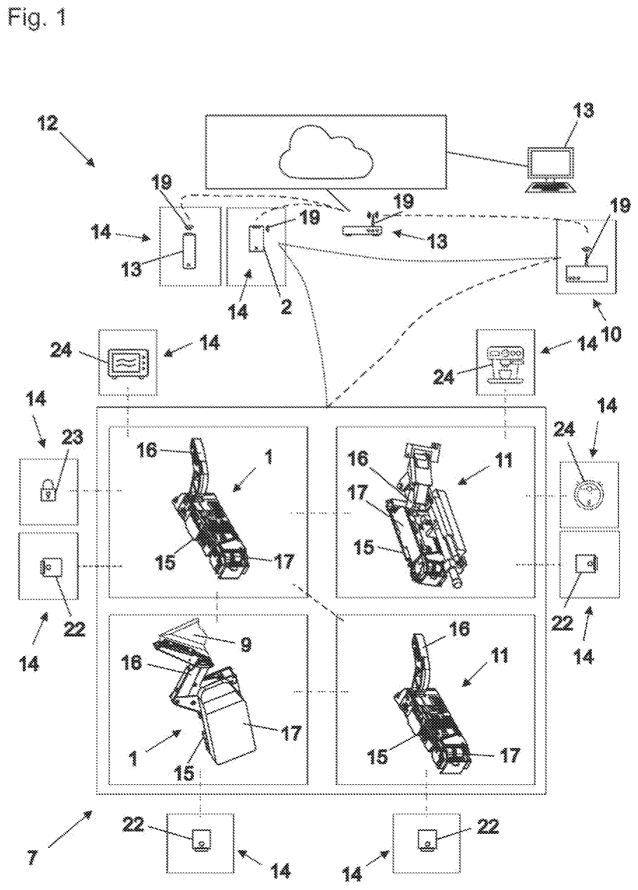

FIG. 1 shows a furniture arrangement 7 comprising four furniture drives 1, each with a storage unit 3 and a moveable furniture part 9 arranged on the furniture drive 1 located at the bottom left, which is indicated in dotted lines. In general, a moveable furniture part 9 arranged on the respective furniture drive 1 is arranged on all furniture drives 1. The furniture part 9, which is moveably positioned on a furniture carcass 8, is arranged by the furniture drive 1 in at least two operating positions relative to the furniture carcass 8. The furniture arrangement 7 comprises an electronic device 2 which is spatially separate from the furniture drive 1, as well as further electronic devices 13 which are in data connection with the electronic device 2 or can be brought into such a connection.

A data communication of the network is generated in a signal-transmitting manner via radio connections, wherein a wired data communication is also possible. The electronic device 2 is present in the form of a smartphone, wherein a further electronic device 13 in the form of a mobile terminal is designed as a speech recognition system. In general, the speech recognition system can also be integrated in the smartphone. In general, electronic devices 2 in the form of computers, tablets, mobile terminals or the like are also possible.

The electronic device 2 and the furniture drives 1 are designed spatially separate from each other.

Command transmitting units 14 are present in the form of the electronic device 2, remote switch elements 22, each of which is in signal-transmitting connection with a furniture drive 1, a data transmission device 10, a furniture lock 23, three household appliances 24 in the form of a microwave, a coffee machine and a vacuum cleaner robot, and additional furniture drives 11.

However, the furniture drives 1 can generally also act as command transmitting units 14 themselves, in order to transmit a digital command to an additional furniture drive 11 following a digital command from a command transmitter 14, in order to generate a synchronized motion of moveable furniture parts 9, for instance. Collision parameters for impending collisions with moveable furniture parts 9 are stored in the form of static parameters in the digital data sets 5, which are present in the storage units 3.

If a furniture drive 1 moves a moveable furniture part 9 to a new operating position, the static parameter is updated in the form of a state parameter. Dynamic parameters such as storage space designations and/or contents designations can be stored at any time, for instance by the additional electronic device 13 in the form of the speech recognition system in the form of a digital data set 5, which is translated from a verbal command in a cloud, the storage unit 3 of the furniture drive 1 and/or via the end user region.

The furniture drives 1 of the furniture arrangement 7 each comprise a fixing device 15 for fixing the furniture drive 1 to a furniture carcass 8, a positioning device 16 with which a moveable furniture part 9 is moveable relative to the furniture carcass 8, as well as a drive unit 17 with which the positioning device 16 is electrically driven.

For reasons of providing an overview, computing units 18, data forwarding devices 19 and storage units 3, which are not visible in the illustration, are comprised in each of the furniture drives 1 and the additional furniture drives 11. The storage units 3 are designed in such a way that digital data sets 5 relating to static parameters and dynamic parameters can be stored in the storage units 3 in a wireless signal transmitting manner via the electronic device 2.

The entire furniture arrangement 7 is configurable in the assembly operator area 4 and in the end user region 6, wherein in general also sub-areas of the network 12 are configurable by the electronic device 2 by depositing digital data sets 5.

For instance, during an assembly of the furniture arrangement 7, an assembler can launch an app installed on the electronic device 2, connect the electronic device 2 to the data transmission device 10 in an assembly operator area, and connect the electronic device 2 to a furniture drive 1, wherein the connection to the furniture drive 1 can transmit a data model of the furniture arrangement 7 to the data transmission device 10 and/or the electronic device 2 can obtain information about entities located in the network 12, such as additional furniture drives 11. The additional electronic device 13 in the form of the speech recognition system can be connected to the network 12 via the electronic device 13, wherein the furniture drives 1 can be actuated by verbal commands from the speech recognition system, the electronic device 2 and/or by tactile commands to the electronic device in order to move moveable furniture parts 9. Static parameters can be stored at any time to the furniture drives 1.

For instance, after an assembly of the furniture arrangement 7 has been completed, a user can start an app installed on the electronic device 2, place the furniture arrangement 7 digitally in an end user region, connect the electronic device 2 to a furniture drive 1, and configure all entities or sub-areas of the network 12 located within the latter, such as the additional furniture drives 11, by storing dynamic parameters. A connection to a furniture drive 1 is sufficient in order to be able to obtain all information of the network 12, such as the stored data sets 5.

Should problems of any kind arise during usage of the furniture drives 1, the problems can be remedied by a support access and/or by step-by-step instructions, wherein a guided process can make the need for skilled personnel obsolete, and a feedback for specific errors, for instance in the network or in case of insufficient assembly, can be generated and displayed.

A system update via the electronic device 2 can lead to an increased level of performance and extended functionality of the furniture arrangement 7. Error diagnoses can be anonymously forwarded to a support for analysis and/or evaluation, and this support can provide assistance in using the furniture arrangement 7 via a help dialog.

For instance, an error message can comprise information about a problematic network structure, an incorrect adjustment of a drive unit, an inadequate installation depth, a constant pressing of a moveable furniture part on a radio switch and/or a faulty firmware, which can be displayed and/or forwarded to the user and/or assembler at the electronic device 2.

Via the electronic device 2, furniture drives 1 can, for instance, be assigned to additional furniture drives 11 for collision avoidance and/or can be coupled to them for synchronization. Subsequently, a data model of the furniture arrangement 7, such as a kitchen, can be created, wherein each furniture drive 1 knows the additional furniture drives 11 and command transmitting units 14 assigned to it, wherein the additional furniture drives 11 and command transmitting units 14 can be determined via a connection to the furniture drive 1 and/or are stored in the digital data set 5 in the form of static parameters.

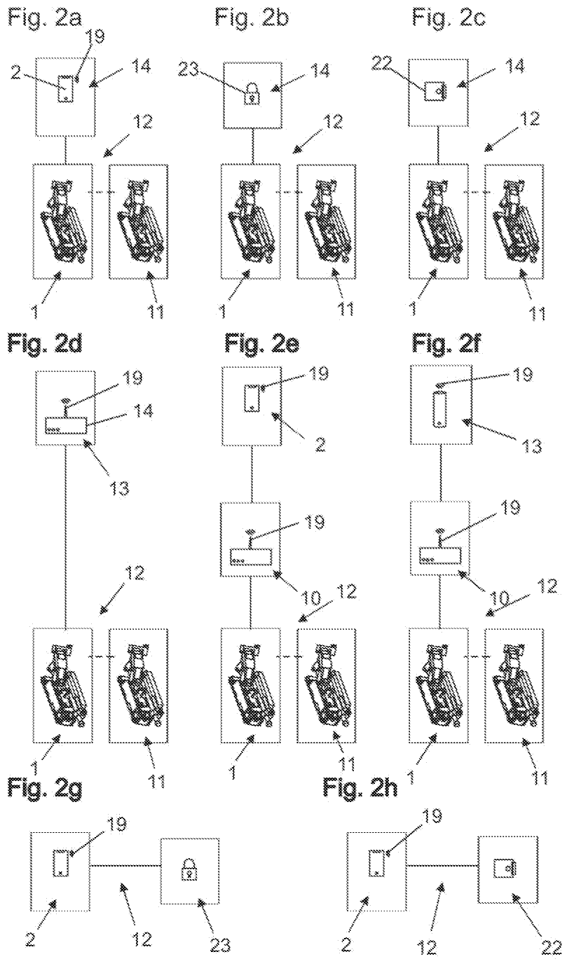

FIG. 2a shows an electronic device 2 in the form of a smartphone with a data forwarding device 19, wherein the electronic device 2 is used to configure a furniture drive 1 as well as a command transmitter 14 of the furniture drive 1.

The furniture drive 1 is in wireless signal transmitting data connection with an additional furniture drive 11, wherein the electronic device 2 communicates with the furniture drive 1 via BLE, and the furniture drive 1 communicates with the additional furniture drive 11 via ESB.

FIG. 2b differs from FIG. 2a in such a way that instead of the electronic device 2, a furniture lock 23 is located in the network 12 as a command transmitter 14. The furniture lock 23 can transmit digital commands to the furniture drive 1, which are forwarded by a data forwarding device 19 to the data forwarding device 19 of the additional furniture drive 11 in order, for instance, to be able to generate a synchronized motion of moveable furniture parts 9.

The furniture lock 23 can send a locking command to the furniture drive 1, or can itself inhibit a motion of the moveable furniture part 9 by a locking state.

FIG. 2c differs from FIG. 2b in such a way that the command transmitter 14 is designed as a remote switch element 22. In general, the command transmitter 14 can also be present in the form of a household appliance 24, such as a microwave oven, which prevents a closing of the moveable furniture part 9 by the furniture drive 1, and/or can be present in the form of a vacuum robot, which requests an opening of the moveable furniture part 9 by the furniture drive 1 in order to be able to park in a piece of furniture 25.

FIG. 2d differs from FIG. 2b in such a way that an additional electronic device 13 is provided as command transmitter 14, which can also be used as data transmission device 10 for data communication between an electronic device 2 and a furniture drive 1. In the network 12, an additional furniture drive 11 is located, which is in direct wireless signal transmitting connection with the furniture drive 1.

FIG. 2e differs from FIG. 2a in such a way that the electronic device 2, with which the furniture drive 1 and the additional furniture drive 11 are configurable, generates a data communication via a data transmission device 10. The electronic device 2 can also generally act as a command transmitter 14. The furniture drive 1 can act as a command transmitter 14 for the additional furniture drive 11, in order to effect a synchronous motion of moveable furniture parts 9, for instance.

The electronic device 2 can be connected to the furniture drive 1 by a user and assembler, wherein the electronic device 2 communicates with the data transmission device 10 via WiFi, and the data transmission device 10 communicates with the furniture drive 1 via ESB.

The data communication between the electronic device 2 and the furniture drive 1 is bidirectional, wherein the electronic device 2 determines information such as a digital data set 5 of the additional furniture drive 11 and the network 12 in which the furniture drive 1 is mapped by connecting to the furniture drive 1 or the data transmission device 10.

The digital data sets 5 of the assembly operator area 4 or the end user region 6 are stored in the storage unit 3 via the data transmission device 10, which is spatially separate from the electronic device 2. The electronic device 2, the data transmission device 10, the furniture drive 1 and the additional furniture drive 11 have a data forwarding device 19 for data communication with any entity of the network 12. The end user region 6 as well as the assembly operator area 4 can be operated tactilely and verbally via the electronic device 2.

FIG. 2f differs from FIG. 2d in such a way that the additional electronic device 13 is designed as a speech recognition system, which can generally be spatially separate from or integrated into the electronic device 2 on which the assembly operator area 4 or the end user region 6 is displayed.

The assembly operator area 4 and the end user region 6 are operable in response to a verbal voice command given by a user. A translation of the verbal voice command can be carried out in a cloud, in the speech recognition system, or in the data transmission device 10. A data communication to the furniture drive 1 is obtained by the data forwarding devices 19.

FIG. 2g shows an electronic device 2 in connection with a furniture lock 23. The user and/or assembler can, for instance, define on the electronic device 2 a time interval in which the furniture lock 23 is to prevent a moveable furniture part 9 from opening, or couple the furniture lock 23 to a specific furniture drive 1.

FIG. 2h differs from FIG. 2g in such a way that the electronic device 2 is in signal-transmitting data communication with a remote switch element 22. The user and/or assembler can, for instance, initiate a software update on the remote switch element 22 via the electronic device 2 or set the remote switch element 22 inactive for a time interval.

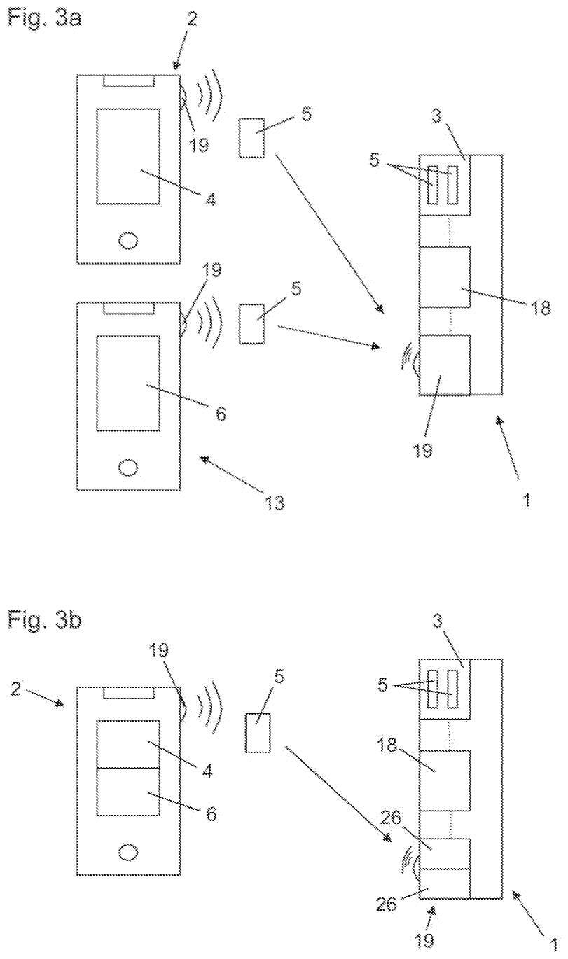

FIG. 3a shows how, in a method for setting up a furniture drive 1, a furniture drive 1 is configured via an electronic device 2 in the form of a smartphone and an additional electronic device 13 in the form of a smartphone. The furniture drive 1 comprises a storage unit 3 in which two digital data sets 5 have already been stored by one of the smartphones.

In an assembly operator area 4 of the electronic device 2, a digital data set 5 relating to static parameters and dynamic parameters is stored in wireless signal transmitting form in the storage unit 3 via the electronic device 2.

In an end user region 6 of the electronic device 2, which is designed as an additional electronic device 13, a digital data set 5 relating to dynamic parameters is stored in the storage unit 3 in a wireless signal transmitting form.

The digital data sets 5 are received by the data forwarding device 19 and stored in the storage unit 3. A computing unit 18 can refer to the digital data sets 5 at any time, for instance for analysis purposes.

In general, the furniture drive 1 is arranged on a moveable furniture part 9 in a kitchen, wherein the electronic device 2 is suitable for setting up a furniture arrangement 7, wherein the furniture arrangement 7 comprises the furniture part 9 movably positioned on a furniture carcass 8 and the furniture drive 1 with the storage unit 3, and the furniture part 9 can be arranged in at least two operating positions relative to the furniture carcass 5 by the furniture drivel.

A computer program product comprising commands which, when executed by a computing unit 18, cause the computing unit 18 to execute a method of setup out of a storage unit 3, which is or can be brought into a data connection with the computing unit 18, is installed on both the electronic device 2 and the additional electronic device 13. For this purpose, the electronic device 2 and the additional electronic device 13 have a storage unit 3 and a computing unit 18 (not visible in the illustration).

In general, a portion of the computer program product or the computer program product can also be installed on the furniture drive 1.

The storage unit 3 of the furniture drive 1 is designed in such a way that in the assembly operator area 4 of the electronic device 2 of the storage unit 3, the digital data set 5 relating to a static or dynamic parameter can be stored in a wireless signal transmitting form via the electronic device 2. Analogously, a digital data set 5 relating to a dynamic parameter can be stored in the end user region 6 of the storage unit 3.

In this embodiment, the assembly operator area 4 is installed as well as displayed on the electronic device 2, and the end user region 6 is installed as well as displayed on the additional electronic device 13 that is spatially separate from the electronic device 2.

In the assembly operator area 4, the furniture drive 1 can be configured, initialized, synchronized, coupled with additional furniture drives 11, command transmitting units 14 or data transmitting devices 10 via reference drives, collision avoidances can be stored and added to a network 12. Furthermore, in the assembly operator area 4, network addresses, link keys and naming can be assigned, current states, log information and operating information can be read out, updates can be updated, error messages, operating instructions and help dialogs for configuration can be displayed. In addition, locking and unlocking as well as deactivating and activating the furniture drive 1 are possible.

FIG. 3b differs from FIG. 3a in such a way that the assembly operator area 4 and the end user region 6 are installed on the same electronic device 2. The assembly operator area 4 and the end user region 6 are separated from each other by separate logins and separate apps on the electronic device 2. The assembly operator area 4 evoked by the computer program product and the end user region 6 are both displayable on the electronic device 2.

In the assembly operator area 4 and the end user region 6, data communication between the electronic device 2 and the furniture drive 1 is encrypted, and enabled during defined time windows. The data forwarding device 19 of the furniture drive 1 has an ELB module 26 for data communication with the electronic device 2 via ELB, and an ESB module for data communication with a command transmitter 14, a data transmission device 10 or an additional furniture drive 11 via ESB.

Digital commands of the command transmitter 14 and the data transmitting device 10 can be transmitted to the data forwarding device 19 of the furniture drive 1 in a wireless signal transmitting manner, wherein the computing unit 18 is designed to compare the digital commands with the digital data sets 5 stored in the storage unit 3. The computing unit 18 is designed to make a selection for executing the digital commands depending on a result of the comparison.

In the end user region 6, a current state can be read out, an active setting/inactive setting and an unlocking/locking can be performed relating to the furniture drive 1, support access can be enabled, an update can be updated, and an operating manual or a help dialog for configuration can be displayed.

Via the data forwarding device 19 of the furniture drive 1, static parameters of additional furniture drives 11, dynamic parameters of additional furniture drives 11 and information such as digital data sets 5 to the network 12 in which the furniture drive 1 is located, can in particular be determined and stored in the storage unit 3 via a data forwarding device 19 of an additional furniture drive 11.

Moveable furniture drives 1 can be controlled by a suitable voice command, wherein for instance a child's voice cannot execute specific functionalities of the furniture drive 1. A voice command enables, for instance, the detection and naming of a kitchen, a living room or storage spaces and contents located therein. By means of a voice command, it is visible to a user and/or an assembler via the electronic device 2 in which current state the furniture drive 1 is. For instance, a speech recognition system of the electronic device 2 can be used to specify a point in time at which a moveable furniture part 9 is to make a coffee machine accessible by the furniture drive 1.

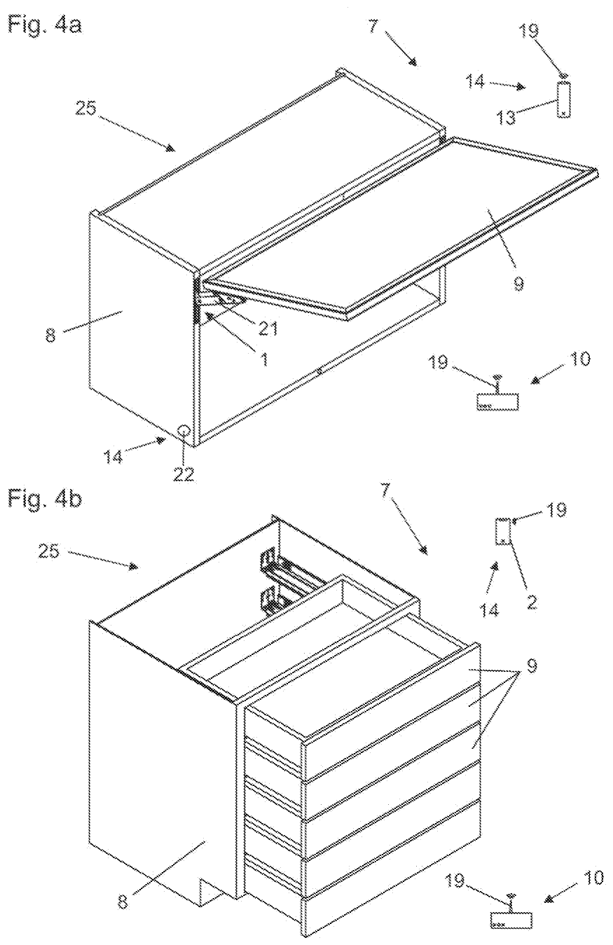

FIG. 4a shows a piece of furniture 25 having a piece of furniture 9 in the form of a furniture flap which is moveably positioned on a furniture carcass 8, wherein the piece of furniture 9 can be arranged in at least two operating positions relative to the furniture carcass 8 by means of two synchronized furniture drives 1 which are arranged on the furniture part 9. The furniture drives 1 can be controlled via a command transmitter 14 in the form of a voice recognition system, wherein a voice command sent by the data forwarding device 19 is translated into a digital command, for instance in a cloud, and is forwarded to the furniture drive 1 via a data transmission device 10.

The command transmitter 14 communicates with the data transmission device 10 via WiFi, wherein the data transmission device 10 communicates with the furniture drive 1 via ESB in order to minimize latency.

The moveable furniture part 9 is jointly moved in parallel between two operating positions relative to the furniture carcass 8 by the furniture drives 1 (in the view, the second furniture drive 1 is hidden by the moveable furniture part 9). The number of operating positions is generally arbitrary. In general, the furniture part 9 can also be present in the form of two furniture parts 9, which can then be individually controlled by the two furniture drives 1, in particular sequentially.

An additional command transmitter 14 in the form of a remote switch element 22 is arranged on the furniture carcass 8 in order to activate the furniture drives 1 by a direct digital command via actuation of the remote switch element 22, and to instruct them to move the moveable furniture part 9, in particular via ESB. The position of the remote switch element 22 is generally arbitrary, wherein this can also be arranged spatially separate from the piece of furniture 25.

In general, the speech recognition system can be in connection with an electronic device 2 in order to configure the furniture drives 1, wherein static parameters in the form of reference parameters, synchronization parameters, coupling parameters, state parameters, and collision parameters are communicated to the furniture drives 1. In this embodiment, the static parameters have already been stored to the storage units 3, wherein a user can conveniently obtain operating the piece of furniture 25 and possibly make adaptations via the end user region 6 of the electronic device 2 or indirectly via the speech recognition system. If a state parameter of the furniture drive 1 changes, the state parameter is changed as a static parameter depending on the present operating position.

Dynamic parameters in the form of time parameters, locking parameters and storage space parameters have been stored in the furniture drives 1 so that the moveable furniture part 9 is moved into an open position by the furniture drives 1 at a defined time, is locked at another defined time and can be controlled by a defined verbal voice command.

The furniture drive 1 each comprises a fixing device 15 for fixing the furniture drive 1 to the furniture carcass 8, a positioning device 16 with which the moveable furniture part 9 is moveable relative to the furniture carcass 8, and a drive unit 17 with which the positioning device 16 can be driven electrically.

FIG. 4b shows a piece of furniture 25 with five pieces of furniture 9 in the form of drawers which are moveably positioned on a furniture carcass 8, which can be moved individually by furniture drives 1. In this embodiment, a speech recognition system integrated in the electronic device 2 is used, which controls the furniture drives 2 via the data transmission device 10 after a translation into a digital command has taken place.

The digital data sets 5 can be stored directly in the storage units 3 of the furniture drives 1 via the electronic device 2, wherein a direct proximity to the furniture drives 1 is not required. For this purpose, BLE is used as the radio protocol. The electronic device 2 can be operated in a tactile and voice-controlled manner.

The five moveable furniture parts 9 can be moved in parallel or sequentially by the furniture drives 1 (hidden in the illustration by the furniture parts 9) between at least two operating positions relative to the furniture carcass 8.

The furniture arrangement 7 comprises the data transmission device 10 and the electronic device 2 as command transmitter 14 and for configuring the furniture drives 1, in order to transmit digital data sets 5 and digital commands to the furniture drives 1.

### LIST OF REFERENCE SIGNS

furniture drive (1)
electronic device (2)
storage unit (3)
assembly operator area (4)
digital data set (5)
end user region (6)
furniture arrangement (7)
furniture carcass (8)
moveable furniture part (9)
data transmission device (10)
additional furniture drive (11)
network (12)
additional electronic device (13)
command transmitter (14)
fixing device (15)
positioning device (16)
drive unit (17)
computing unit (18)
data forwarding device (19)
remote switch element (22)
furniture lock (23)
household appliance (24)
furniture (25)
ELB module (26)

1. A method for setting up at least one furniture drive via at least one electronic device, in particular a mobile terminal, a smartphone or a computer, wherein the at least one furniture drive comprises at least one memory unit, comprising the following method steps, which are preferably to be carried out in chronological order:
in an assembly operator area of the at least one electronic device, at least one digital data set relating to at least one static parameter and/or at least one dynamic parameter is, in particular wireless signal transmitting, stored in the at least one memory unit via the at least one electronic device,
in an end user region of the at least one electronic device, at least one digital data set in relation to the at least one dynamic parameter is, in particular wireless signal transmitting, stored in the at least one memory unit via the at least one electronic device.

2. A method for setting up a furniture arrangement via at least one electronic device, in particular mobile terminal, smartphone or computer, wherein the furniture arrangement comprises at least one furniture part positioned in a moveable manner on a furniture carcass, and at least one furniture drive with at least one memory unit, wherein the at least one furniture part can be arranged by the at least one furniture drive in at least two operating positions relative to the furniture carcass, comprising the following method steps, which are preferably to be carried out in chronological order:
in an assembly operator area of the at least one electronic device, at least one digital data set in relation to at least one static parameter and/or at least one dynamic parameter is, in particular wireless signal transmitting, stored in the at least one memory unit via the at least one electronic device,
in an end user region of the at least one electronic device, at least one digital data set in relation to at least one dynamic parameter is, in particular wireless signal transmitting, stored in the at least one memory unit via the at least one electronic device.

3. The method according to claim 1, wherein the at least one electronic device and the at least one furniture drive are designed spatially separate from each other.

4. The method according to claim 1, wherein the assembly operator area and the end user region are separated from each other, preferably by separate logins and/or separate apps, on the at least one electronic device, wherein it is preferably provided that in the assembly operator area and/or the end user region, a data communication between the at least one electronic device and the at least one furniture drive is enabled in encrypted form and/or during defined time windows.

5. The method according to claim 1, wherein the at least one digital data set of the assembly operator area and/or the end user region of the at least one memory unit is stored via at least one data transmission device spatially separate from the at least one electronic device, wherein it is preferably provided that the at least one electronic device communicates with the at least one data transmission device via WiFi and/or WAN, and/or the at least one data transmission device communicates with the at least one furniture drive via ESB.

6. The method according to claim 1, wherein a data communication between the at least one electronic device and the at least one furniture drive is bidirectional, wherein it is preferably provided that the at least one electronic device determines information, preferably at least one digital data set, of at least one additional furniture drive, and/or of a network in which the at least one furniture drive is mapped, by a connection with at least one, preferably exactly one, furniture drive, and/or at least one, preferably exactly one, possibly present existing data transmission device.

7. The method according to claim 1, wherein the assembly operator area is installed on at least one electronic device, and the end user region is installed on at least one additional electronic device spatially separate from the at least one electronic device, or the assembly operator area, and the end user region are installed on the same electronic device.

8. The method according to claim 1, wherein the at least one electronic device communicates with the at least one furniture drive via BLE.

9. The method according to claim 1, wherein the assembly operator area and/or the end user region can be operated depending on a verbal voice command given by a user, preferably with user identification, and/or in a tactile manner.

10. The method according to claim 1, wherein the at least one static parameter is provided in the form of a reference parameter, synchronization parameter, coupling parameter, state parameter and/or collision parameter, wherein it is preferably provided that the state parameter is changed depending on at least one operating position.

11. The method according to claim 1, wherein the at least one dynamic parameter is provided in the form of a time parameter, locking parameter, and/or storage space parameter.

12. The method according to claim 1, wherein in the assembly operator area:
the at least one furniture drive is coupled to at least one additional furniture drive and/or synchronized via a reference drive to be carried out by a user,
the at least one furniture drive is initialized via a reference drive to be carried out by a user,
the at least one furniture drive is coupled to at least one command transmitter, wherein preferably the at least one command transmitter is initialized via a reference drive to be carried out by a user,
a collision avoidance is stored in the at least one memory unit via a reference drive to be carried out by a user, and/or
the at least one furniture drive, at least one command transmitter and/or at least one data transmission device are added to a network.

13. The method according to claim 1, wherein in the assembly operator area:
at least one network address, at least one link key and/or at least one naming is assigned and/or allocated,
at least one current state, at least one piece of log information and/or at least one piece of operating information of the at least one furniture drive, at least one possibly present command transmitter and/or a possibly present data transmission device is read out, preferably at least one error message is displayed for at least one furniture drive and/or a possibly present data transmission device and/or a possibly present command transmitter,
at least one furniture drive, at least one data transmission device and/or at least one command transmitter is added to form a network,
at least one furniture drive, at least one possibly present data transmission device and/or at least one possibly present command transmitter is reset, unlocked or locked and/or set active or inactive,
at least one update, preferably firmware update, of the at least one electronic device, of the at least one furniture drive, of a possibly present command transmitter and/or of a possibly present data transmission device is updated, and/or
at least one operating manual and/or help dialog for configuration is displayed.

14. The method according to claim 1, wherein in the end user region:
at least one current state of the at least one furniture drive is read out,
at least one furniture drive, at least one possibly present data transmission device and/or at least one possibly present command transmitter is set active or inactive and/or unlocked or locked,
at least one support access, in particular live support access, is made possible, at least one update, preferably firmware update, of the at least one electronic device, the at least one furniture drive, a possibly present command transmitter and/or a possibly present data transmission device is updated, and/or
at least one operating manual and/or help dialog for configuration is displayed.

15. The method according to claim 1, wherein the at least one furniture drive comprises at least one fixing device for fixing the furniture drive to a furniture carcass, at least one positioning device, with which at least one moveable furniture part is moveable relative to the furniture carcass, and at least one drive unit, with which the at least one positioning device can be driven, in particular electrically, wherein it is preferably provided that the at least one furniture drive comprises at least one computing unit.

16. The method according to claim 1, wherein the at least one furniture drive comprises at least one data forwarding device via which, preferably via a data forwarding device of at least one additional furniture drive, at least one static parameter of at least one additional furniture drive, at least one dynamic parameter of at least one additional furniture drive and/or at least one piece of information, preferably at least one digital data set relating to a network in which the at least one furniture drive is located, is determined and/or stored in the at least one memory unit.

17. The method according to claim 2, wherein the entire furniture arrangement can be configured in the assembly operator area and/or in the end user region.

18. A computer program product comprising commands, which, when executed by a computing unit, cause the computing unit to execute a method according to at least one of the preceding claims using a memory unit which is or can be brought into a data connection with the computing unit.

19. The computer program product according to claim 18, wherein an assembly operator area evoked by the computer program product can be displayed on at least one electronic device, and an end user region evoked by the computer program product can be displayed on at least one electronic device that is spatially separate therefrom, or the assembly operator area evoked by the computer program product and the end user region (6) can be displayed on the same electronic device.

20. A furniture arrangement comprising at least one furniture drive having at least one memory unit and at least one furniture part movably positioned on a furniture carcass, wherein the at least one furniture part can be arranged in at least two operating positions relative to the furniture carcass by means of the at least one furniture drive and at least one electronic device, in particular a mobile terminal, a smartphone or a computer, in particular spatially separate from the at least one furniture drive, wherein it is preferably provided that the at least one furniture drive and the at least one electronic device each comprise at least one data forwarding device, wherein the at least one memory unit is designed such that
at least one digital data set relating to at least one static parameter and/or at least one dynamic parameter can be stored, in particular wireless signal transmitting, in an assembly operator area of the at least one electronic device of the at least one memory unit via the at least one electronic device,
in an end user region of the at least one electronic device of the at least one memory unit, at least one digital data set relating to at least one dynamic parameter can be stored, in particular wireless signal transmitting, via the at least one electronic device.

21. The furniture arrangement according to claim 20, wherein the furniture arrangement comprises at least one data transmission device and/or at least one command transmitter for transmitting at least one digital data set and/or at least one digital command.

22. The furniture arrangement according to claim 20, wherein the at least one command transmitter is designed in the form of the at least one electronic device, a remote switch element, a data transmission device, a furniture lock, a household appliance and/or an additional furniture drive.

23. A furniture drive for the furniture arrangement according to claim 20, comprising:
at least one fixing device for fixing the furniture drive to a furniture carcass,
at least one positioning device, with which at least one moveable furniture part can be moved relative to the furniture carcass,
at least one drive unit, by means of which the at least one positioning device can be driven, in particular electrically,
in particular at least one computing unit and/or at least one data forwarding device, and
at least one memory unit,
wherein the at least one storage unit is designed in such a way that at least one digital data set relating to at least one static parameter and/or dynamic parameter can be stored, in particular wireless signal transmitting, in the at least one storage unit via at least one electronic device, in particular a mobile terminal, a smartphone or a computer.

24. The furniture drive according to claim 23, wherein the at least one data forwarding device comprises at least one ELB module for data communication with the at least one electronic device via ELB, and/or at least one ESB module for data communication with at least one command transmitter, at least one data transmission device and/or at least one additional furniture drive via ESB.

25. The furniture drive according to claim 23, wherein at least one digital command of the at least one command transmitter and/or of the at least one data transmission device can be transmitted to the at least one data forwarding device of the at least one furniture drive, preferably wireless signal transmitting, wherein the at least one computing unit is designed to compare the at least one digital command with at least one digital data set stored in the at least one memory unit, and the at least one computing unit is designed to make a selection for executing the at least one digital command depending on a result of the comparison.
